(19) United States
(12) Patent Application Publication
(10) Pub. No.: US 2003/0040998 A1
(43) Pub. Date: Feb. 27, 2003

(54) Systems and methods of direct marketing

(76) Inventors: John Jordan Kogler, Tustin, CA (US); Clare Whitney Kogler, Tustin, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 10/158,089

(22) Filed: May 29, 2002

Related U.S. Application Data
(60) Provisional application No. 60/315,279, filed on Aug. 27, 2001.
(60) Provisional application No. 60/355,491, filed on Feb. 7, 2002.

(51) Int. Cl. G06F 17/60

(52) U.S. Cl. 705/35

(57) ABSTRACT

The present disclosure includes a system and method of direct marketing of secondary products through channels opened by the direct marketing of primary products, thereby acquiring new customers for the secondary products. The system and method establishes communication between a customer of the primary products and an offering entity of the secondary products. Moreover, the systems and methods encourage customers to take positive actions, such as return an application, use one or more secondary products, activate one or more accounts, or the like.

### REFERENCE TO RELATED APPLICATION

The present application claims priority benefit under 35 U.S.C. §119(e) from U.S. Provisional Application No. 60/315,279, filed Aug. 27, 2001, entitled “TARGETED RECEPTIVITY MARKETING (“TARMARK”),” and from U.S. Provisional Application No. 60/355,491 filed Feb. 7, 2002 entitled “TARGETED RECEPTIVITY MARKETING (“TARMARK”),” both of which are incorporated herein by reference.

### FIELD OF THE INVENTION

The present invention relates to the field of product marketing. More specifically, the invention relates to marketing financial services to a pre-selected or targeted customer base.

### BACKGROUND OF THE INVENTION

Financial institutions, like virtually all businesses, seek additional revenue sources and enhanced profitability. One source of enhanced profitability for many financial institutions includes the credit card because the interest rates charged for credit card debt are often much higher than the interest rates charged for business and consumer debt. Therefore, there is considerable competition among financial institutions to increase their number of activated credit cards, thereby increasing their profits.

Because many financial institutions use ineffective marketing techniques, many financial institutions can spend as much as hundreds of dollars to acquire each new activated credit card. For example, one solution that many financial institutions employ to attempt to gain new credit card activations is mass mailings. This marketing technique results in most consumers receiving dozens of credit card applications through the mail each year. Thus, financial institutions often find mass mailing acceptance rates to be very low, sometimes as low as 0.6%. In addition to poor realizations, mass mailings often attract respondents constituting higher credit risk than the financial institution finds acceptable. Thus, mass mailing is expensive, realizes few new credit card activations, and may even annoy the very customers the financial institution is seeking.

Another ineffective marketing technique that some financial institutions use to attract new credit card activations includes offering their credit card in conjunction with another business. For example, when a customer contacts a business, such as Sears or Home Depot, to make a purchase or to inquire with customer service, the customer can be offered a credit card that carries the brand of the business but is issued by the financial institution. An example of this is a Sears credit card issued by, for example, Visa. This “Sears” card will often function as a Visa card.

The foregoing card co-branding also includes a number of drawbacks. For example, when problems arise, the customer, having only dealt with the business and not the financial institution, will often contact the business for inquires more appropriately handled by the financial institution. Thus, the business, and not the financial institution, will be associated with negative customer service inquires and complaints which can negatively impact the customer's loyalty to the business. An additional drawback of this card co-branding includes the business incurring the overhead costs associated with the credit card customer service issues.

Direct marketers, like the foregoing financial institutions, are another business that seeks additional revenue sources and enhanced profitability. Direct marketers generally sell goods or services to the public through mass-market advertising, often designed to encourage customers to make purchases over the telephone or the Internet. To supplement revenues generated through the foregoing direct marketing, direct marketers may offer callers one or more secondary products in addition to the advertised primary product. Often this second product is unrelated to the primary product that prompted the original phone call. These secondary products can include free trial offers, such as discount buying clubs, discount travel packages, discount travel clubs, magazine subscriptions, or the like. In many cases, when a caller fails to subsequently cancel the free trial offer, the vendor of the offer will charge the caller's credit card account. Generally, the vendor compensates the direct marketer for each offer and/or each successful sale of the product.

However, the foregoing secondary product marketing can lead to a number of drawbacks for the direct marketers. For example, customers may and often do become concerned at being charged for products and services which were automatically activated upon a failure to cancel. Moreover, customers can feel confused by secondary product marketing and often associate any hard feelings caused by the confusion with the business contact, which in this case is the direct marketer that originally pitched them the “free” products. Thus, secondary product marketing can erode the direct marketer's customer base, thereby damaging revenue from primary sales. Additionally, consumer groups and lawmakers are beginning to question the appropriateness of charging consumers for simply failing to act. Furthermore, customers are becoming increasingly resistant to these “free” programs, often having heard similar pitches many times, thus resulting in decreasing customer acceptance rates. Accordingly, direct marketers desire additional revenue enhancing programs that do not create customer dissatisfaction and consumer rights issues.

### SUMMARY OF THE INVENTION

Therefore, a need exists for a marketing strategy whereby the cost of acquiring customers is reduced and the acceptance or activation rate is increased without creating consumer rights and customer loyalty problems. Accordingly, aspects of the present disclosure include a system and method of acquiring new customers for secondary products through channels opened by the direct marketing of primary products. The system and method avoid the consumer rights and customer loyalty drawbacks of many co-branding offerings or free-trial-period product offerings by establishing communication between a customer of a primary product and an offering entity of the secondary product, and by employing positive actions by the customer before activating an account.

For example, according to an embodiment of the present invention, a marketing system includes one or more primary marketers interacting with one or more secondary marketers to acquire new customers for secondary products through channels opened by the direct marketing of primary products. Thus, when a customer responds to an advertisement of the primary products through the primary marketer, such as a direct marketer, the primary marketer offers an application for secondary goods or services (“secondary products”) to the customer. When the customer accepts the offer for an application, the primary marketer provides the secondary marketer customer information on how to contact the accepting customer. The secondary marketer then establishes communication with the customer by providing the customer with the application.

In one embodiment, the customer may take one or more positive actions in addition to, for example, requesting an application during the initial contact with the primary marketer. For example, the customer may return the application, activate, use or otherwise accept the secondary products, or the like, before incurring any liabilities to the secondary marketer. When the customer fails to take additional positive actions, the secondary marketer can perform follow-up communications to encourage the customer to take the foregoing positive actions. The encouragement can include offering incentives from, for example, third-party vendors. For example, the encouragement can include providing a positive balance in a financial instrument to be spent purchasing products of the third-party vendors.

According to one embodiment, the secondary marketer may include a market facilitator and an offering entity. The offering entity can include the entity offering the secondary products. For example, the offering entity may comprise financial institutions offering credit cards or the like, telephone companies offering local, long distance, or mobile services, combinations of the same, or the like. The offering entity may also comprise on-line companies seeking subscribers or customers, internet service providers, group health care providers, pharmaceutical companies, or the like. The market facilitator, on the other hand, may associate one or more primary marketers with one or more offering entities, may perform the follow-up communications, may categorize, sort or otherwise manipulate the customer information, provide product or demographic information to the offering entity, help customize the application based on the customer information, or the like.

In an embodiment where a financial institution is marketing credit cards to the customers of direct marketers, the marketing system includes a marketing agent, a direct marketer and a financial institution, such as a credit card company or issuer. Similar to the marketing system disclosed in the foregoing, the marketing agent interacts with the direct marketer and the credit card company to acquire new credit card activations through channels opened by the direct marketing of primary products.

According to yet another embodiment, a targeted marketing process can acquire customers for secondary products through channels opened by the direct marketing of primary products, in a manner similar to that described above. For example, the targeted marketing process can include gathering customer information for customers who accept an application for a secondary product when they communicate with a primary marketer about a primary product. The targeted marketing process can also include disseminating the customer information to a secondary marketer who sends, for example, applications to the customers, and monitoring whether the customer takes one or more positive actions, such as, for example, returning the applications, activating the secondary product, or the like. The targeted marketing process can also include distributing a fee associated with, for example, the customer taking one or more of the forgoing positive actions.

Other embodiments of the targeted marketing process include categorizing customers based on, for example, the primary product, customer demographic information, purchase histories, credit ratings, or the like. According to one embodiment, the categorizations may include coding the customer information. The categorizing of customer information advantageously allows the offering entity to customize the offered secondary product to the customer.

For purposes of summarizing the invention, certain aspects, advantages and novel features of the invention have been described herein. Of course, it is to be understood that not necessarily all such aspects, advantages or features will be embodied in any particular embodiment of the invention.

### BRIEF DESCRIPTION OF THE DRAWINGS

A general architecture that implements the various features of the invention will now be described with reference to the drawings. The drawings and the associated descriptions are provided to illustrate embodiments of the invention and not to limit the scope of the invention. Throughout the drawings, reference numbers are re-used to indicate correspondence between referenced elements. In addition, the first digit of each reference number indicates the figure in which the element first appears.

FIG. 1 is a block diagram illustrating a targeted receptivity marketing system according to an embodiment of the present invention.

FIG. 2 is a flowchart illustrating a marketing process according to an embodiment of the present invention.

FIG. 3 is a flowchart further illustrating a gathering process of the marketing process of FIG. 2, according to an embodiment of the invention.

FIG. 4 is a block diagram illustrating a credit card marketing system according to an embodiment of the present invention.

FIGS. 5A and 5B are flowcharts illustrating a credit card marketing process according to an embodiment of the present invention.

### DETAILED DESCRIPTION OF THE PREFERRED EMBODIMENT

The present disclosure includes a system and method of acquiring new customers for secondary products through channels opened by the direct marketing of primary products. The system and method avoid the consumer rights and customer loyalty drawbacks of many co-branding offerings or free-trial-period product offerings by establishing communication between a customer of a primary product and an offering entity of the secondary product, and by employing positive actions by the customer before activating an account.

For example, according to an embodiment of the present invention, a marketing system includes one or more primary marketers interacting with one or more secondary marketers to acquire new customers for secondary products through channels opened by the direct marketing of primary products. Thus, when a customer responds to an advertisement of the primary products through the primary marketer, such as a direct marketer, the primary marketer offers an application for secondary goods or services (“secondary products”) to the customer. When the customer accepts the offer for an application, the primary marketer provides the secondary marketer customer information on how to contact the accepting customer. The secondary marketer then establishes communication with the customer by providing the customer with the application.

In one embodiment, the customer takes positive actions before incurring any liabilities to the secondary marketer. For example, the customer may return the application, activate, use or otherwise accept the secondary products, or the like,

Based on the foregoing disclosure, the marketing system advantageously establishes communication between the customer and the secondary marketer. Thus, the primary marketer advantageously avoids customer loyalty problems as issues arising from the secondary products can now be associated by the customer with the secondary marketer. Moreover, because the customer takes additional positive actions before incurring liabilities to the secondary marketer, the marketing system advantageously avoids consumer rights issues relating to billings based on customer inaction.

In one embodiment, when the customer fails to take additional positive actions, such as, for example, returning the application, activating, using or otherwise accepting the secondary products, or the like, the secondary marketer can perform one or more follow-up communications to encourage the customer to take the foregoing positive actions. The encouragement can include offering incentives, such as incentives from third-party vendors. For example, the encouragement can include providing a positive balance in a financial instrument to be spent purchasing products of the third-party vendors.

Because the customer agreed to be contacted by the secondary marketer during the initial contact with the primary marketer, the customer effectively pre-authorized the secondary marketer to perform follow-up contacts, thereby advantageously avoiding potential consumer rights issues facing cold-calling marketers, such as contacting someone on a do-not-solicit list, or the like. Moreover, such follow-up contacts advantageously increase, for example, the number of customer activations, acceptances, or uses of the secondary products.

According to one embodiment, the secondary marketer may include a market facilitator and an offering entity. The offering entity can include the entity offering the secondary products. For example, the offering entity may comprise financial institutions offering credit cards, financial investments, instruments, or the like, telephone companies offering local, long distance, or mobile services, combinations of the same, or the like. The offering entity may also comprise on-line companies seeking subscribers or customers, internet service providers, group health care providers, pharmaceutical companies, or the like. The market facilitator, on the other hand, may associate one or more primary marketers with one or more offering entities, may perform the follow-up communications, may categorize, sort or otherwise manipulate the customer information, provide product or demographic information to the offering entity, help customize the application based on the customer information, or the like.

Through the use of the market facilitator, the marketing system advantageously allows the entity actually offering the secondary products to remain focused on providing the same. Moreover, the marketing system allows the market facilitator to advantageously focus on maintaining and expanding relationships with direct marketers and offering entities, following-up customer contacts, or the like.

In an embodiment where a financial institution is marketing credit cards to the customers of direct marketers, the marketing system includes a marketing agent, a direct marketer and a financial institution, such as a credit card company or issuer. Similar to the marketing system disclosed in the foregoing, the marketing agent interacts with the direct marketer and the credit card company to acquire new credit card activations through channels opened by the direct marketing of primary products. Thus, when a customer responds to an advertisement of the primary products, the direct marketer offers an application for one or more credit cards. When the customer accepts the offer for an application, the direct marketer provides, for example, the marketing agent with information on how to contact the accepting customer. This information is forwarded to the credit card company, who then establishes communication with the customer by providing the customer with the application. According to one embodiment, the marketing agent performs follow-up communications to encourage the customer to complete the application, return it to the credit card company, activate, receive or use the secondary product, some or all of the same, or the like. In one embodiment, the encouragement can include offering incentives from, for example, third-party vendors when the customer performs some or all of the foregoing actions. For example, the encouragement can include, for example, a positive balance in a financial instrument to be spent purchasing products at one or more of the foregoing vendors.

According to yet another embodiment, a targeted marketing process can acquire customers for secondary products through marketing channels opened by the direct marketing of primary products, in a manner similar to that described above. For example, the targeted marketing process can include gathering customer information for customers who accept an application for a secondary product when they communicate with a primary marketer about a primary product. The targeted marketing process can also include disseminating the customer information to a secondary marketer who sends, for example, applications to the customers, and monitors whether the customer takes one or more positive actions, such as, for example, returning the applications, activating the secondary product, or the like. The targeted marketing process can also include distributing a fee associated with, for example, the customer taking one or more of the foregoing positive actions.

Thus, the targeted marketing process advantageously establishes communication between the customer and the secondary marketer. Also, the primary marketer advantageously avoids customer loyalty problems because the customer will associate issues arising from the secondary products with the secondary marketer. Moreover, because the customer takes additional positive actions before incurring liabilities, the marketing system advantageously avoids consumer rights issues relating to billings based on customer inaction.

According to one embodiment, the marketing process can advantageously distribute fees or other compensation for a wide number of positive activities. For example, the secondary marketer may distribute fees for each positive action taken by a customer, for activation or use of one or more secondary products, for the contact information associated with each application sent, received, or the like, for each offer of the secondary product to the customer of the primary product, some or all of the foregoing, or the like. Additionally, a skilled artisan will recognize from the disclosure herein that the fee for one activity may be different for fees related to other activities.

Other embodiments of the targeted marketing process include categorizing customers based on, for example, the primary product, customer demographic information, purchase histories, credit ratings, or the like. According to one embodiment, the categorizations may include coding the customer information. The categorizing of customer information advantageously allows the offering entity to customize offerings to the customer.

To facilitate a complete understanding of the invention, the remainder of the detailed description describes the invention with reference to the drawings, wherein like reference numbers are referenced with like numerals throughout.

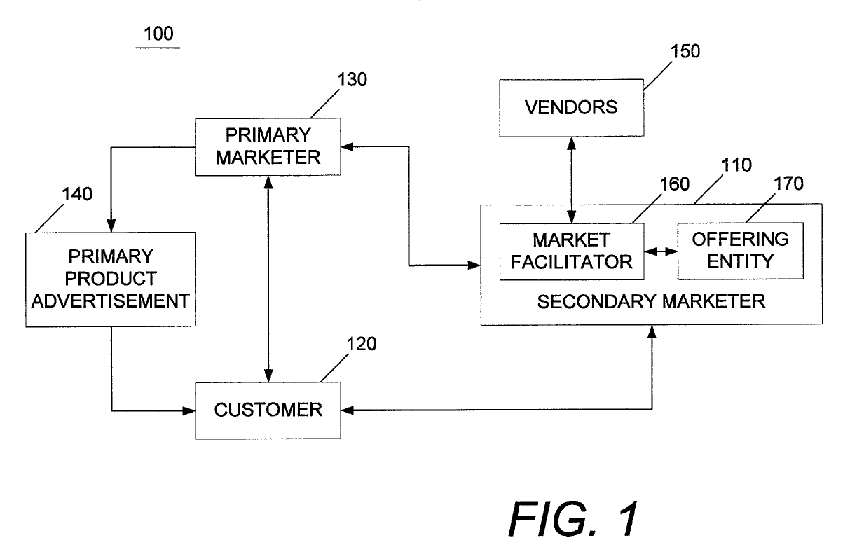

FIG. 1 illustrates a targeted receptivity marketing system 100 according to an embodiment of the present invention. A secondary marketer 110 acquires new customers 120 through the marketing actions of a primary marketer 130. The secondary marketer 110 comprises an entity or business offering a secondary product. The secondary product may be offered through an application. The secondary marketer 110 can associate with one or more primary marketers 130, can interact with third-party vendors 150 to provide incentives, can perform customer follow-up communications, can categorize, sort or otherwise manipulate information, can customize the application based on the customer information, or the like. The primary marketer 130 takes marketing actions such as creating and distributing a primary product advertisement 140 and offers the secondary product to the customers 120 responding to the primary product advertisement 140.

In a further embodiment, the secondary marketer 110 comprises a market facilitator 160 and an offering entity 170. The offering entity 170 comprises the business offering the secondary product. The market facilitator 160 can associate one or more primary marketers 130 with one or more offering entities 170, can perform customer follow-up communications, can categorize, sort or otherwise manipulate information, can provide product or demographic information to the offering entity 170, can help customize the application based on the customer information, or the like. This allows the offering entity 170 to remain focused on the business of providing the secondary product, and allows the market facilitator 160 to advantageously focus on secondary product marketing activities such as maintaining and expanding relationships with primary marketers 130, following-up customer contacts, and the like, for the offering entity 170.

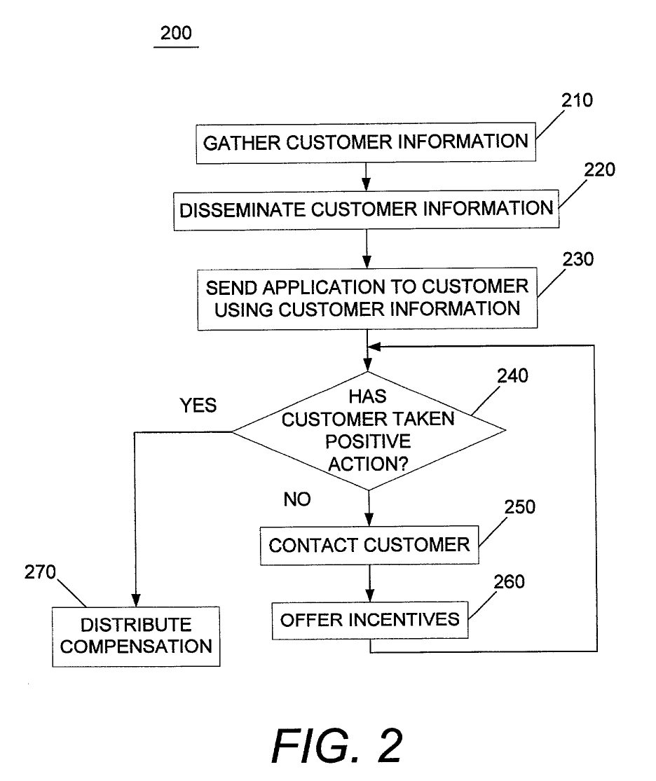

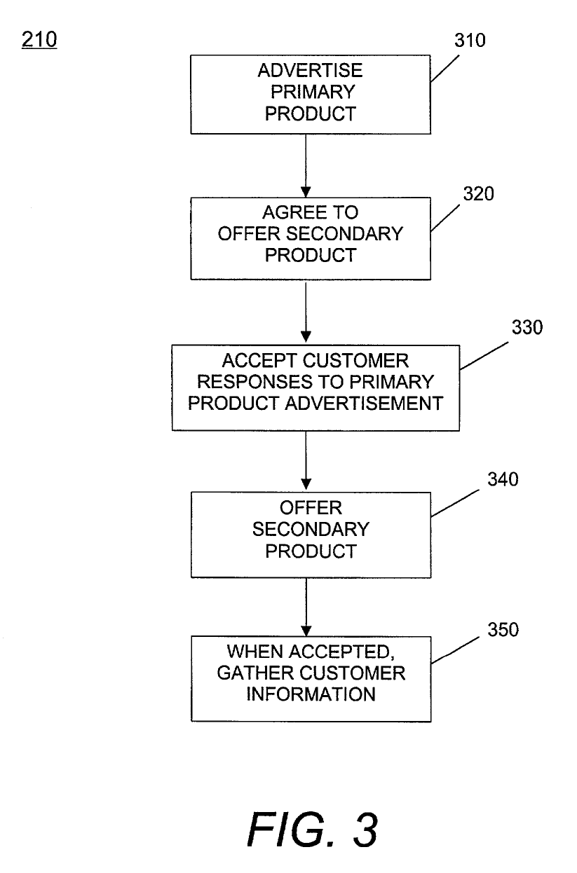

FIG. 2 illustrates marketing process 200 according to an embodiment of the present invention. Beginning at block 210, the primary marketer 130 gathers customer information. Customer information can be gathered by customer contact through telephone sales, mass mailings, Internet banners, websites, primary marketers 130, and the like. One embodiment of the process of gathering customer information 210 will be further disclosed with reference to FIG. 3.

At block 220, the primary marketer 130 transfers customer information to the secondary marketer 110. The customer information comprises customer name and customer contact data and allows the secondary marketer 110 to send the customer 120 the application for the secondary product. The customer information may also comprise a customer category, a customer list, and the like, and will be further disclosed with reference to FIG. 3. Customer information further comprises which customers return the application, which customers receive the secondary product, and which customers activate or use the secondary product.

At block 230, the secondary marketer 110 sends the customer 120 the application for the secondary product. The form and content of the application can advantageously be based, at least in part, on the customer information, the customer category, the customer list, or the like. Additionally, the secondary marketer 110 may customize the appearance of the application, based, at least in part, on the above customer data. The application can be delivered through any conventional means, including mail, a special delivery service, email, or the like.

At block 240, the secondary marketer 110 verifies if the customer 120 has taken a positive action, such as, for example, returning a completed application to the secondary marketer 110, or activating, using or otherwise accepting the secondary product.

For example, if the customer 120 has not returned the completed application for the secondary product to the secondary marketer 110 within a predetermined period of time, the process moves to block 250 where the secondary marketer 110 contacts the customer 120 using, for example, the customer data supplied by the primary marketer 130. In a further embodiment, the market facilitator 160 contacts the customer 120 if the customer 120 has not returned the completed application for the secondary product to the offering entity 170 within a predetermined period of time.

At block 260, the secondary marketer 110 may offer the customer 120 incentives to return the completed application. The incentives can include a courier service to pick up and deliver the application, a free product, a discount associated with the secondary product, and the like. Additionally, the secondary marketer 110 may form agreements with third-party vendors 150 to offer incentives such as a positive balance in a financial instrument to be spent purchasing products at one or more of the third-party vendors 150. In one embodiment, the market facilitator 160 performs the customer contact, incentive offer, incentive agreements, or the like.

After a predetermined period of time, the secondary marketer 110, at block 240, again determines if the customer 120 has taken the positive action, such as, for example, activating, using, or otherwise accepting the secondary product. If, for example, the customer 120 has returned the completed application and the secondary marketer 110 has sent the customer 120 the secondary product, but the customer 120 has not activated the secondary product, the secondary marketer 110 contacts the customer 120 in block 250. In one embodiment, the market facilitator 160 contacts the customer 120 if the customer 120 has not activated the secondary product within a predetermined period of time.

At block 260, the secondary marketer 110 may again offer the customer 120 enhanced incentives to now activate the secondary product. The incentives can include those described in the foregoing, or the like. Moreover, the market facilitator 160 can perform the customer contact, incentive offer, incentive agreements, or the like.

At block 240, the secondary marketer 110 may again determine whether or not the customer 120 has taken the appropriate positive action. If not, the process again proceeds through the loop formed by blocks 240, 250, and 260, where the secondary marketer 110 again follows-up with the customer 120 and may offer incentives to encourage the customer 120 to return the application or activate the product.

If, in block 240, the customer 120 has performed a positive action, the process proceeds to block 270 where compensation is distributed. For example, the primary marketer 130 can receive compensation for each offer of the secondary product application, each acceptance thereof, each successful secondary product activation, or the like. In addition, the market facilitator 160 can receive compensation for some or all of the foregoing actions. In one embodiment, the offering entity may compensate the market facilitator based on an offering entity-market facilitator agreement while the market facilitator may then compensate the primary marketer based on a market facilitator-primary marketer agreement. In one embodiment, the foregoing agreements or portions thereof may be combined or separate agreements.

When the secondary marketer 110 sends the application for the secondary product to the customer 120 of the primary marketer 130, the secondary marketer 110 advantageously establishes direct communication with the customer 120 of the primary marketer 130. This avoids consumer rights and customer loyalty drawbacks for the primary marketer 130. Positive customer reactions are further reinforced by employing positive customer actions before the customer incurs liabilities. Additionally, follow-up customer contacts advantageously increase customer activation, acceptance or use of the secondary product.

FIG. 3 illustrates an embodiment of a gathering process such as the process used to gather customer information at block 210 of FIG. 2. Beginning at block 310, the primary marketer 130 advertises the primary product through the advertisement 140. Advertisement media can be print, magazines, magazine inserts, newspapers, billing inserts, direct mailings, mass mailings, television, radio, voice mail, email, Internet, websites, Internet banners, catalogs, and the like. According to one embodiment, the primary marketer 130 may offer more than one primary product through different advertisements 140.

At block 320, the secondary marketer 110 and the primary marketer 130 agree to have the primary marketer 130 offer the secondary product of the secondary marketer 110 to customers 120 of the primary marketer 130. According to one embodiment, the market facilitator 160 facilitates the foregoing agreements between the primary marketer 130 and the offering entity 170. This allows the offering entity 170 to remain focused on the business of providing the secondary product, and allows the market facilitator 160 to advantageously focus on secondary product marketing activities such as maintaining and expanding relationships with primary marketers 130.

At block 330, the customer 120 receives the primary product advertisement 140 and responds to the primary marketer 130. For example, the customer 120 may contact the primary marketer 130 for customer service, for general inquiries, to purchase the primary product, or the like. The customer 120 can contact the primary marketer 130 by telephone, voice mail, email, mail, and the like. During this contact, at block 340, the primary marketer 130 offers the customer 120 the secondary product. The secondary marketer 110 may offer one or more applications for one or more secondary products. According to one embodiment, the secondary product can comprise one or more of a credit card or a financial service from a financial institution, local, long distance or mobile service from a telephone company, a subscription to an online company, internet service from an internet service provider, a health care plan or a prescription plan from a group health care provider, or the like.

The primary marketer 130, the secondary marketer 110, or the market facilitator 160 may customize how the secondary product is offered or which secondary product is offered based, at least in part, on customer information noted during the customer response to the primary product advertisement 140. For example, the customer 120 who contacts the primary marketer 130 regarding an inexpensive primary product may be offered a different secondary product than the customer 120 inquiring about an expensive primary product.

At block 350, the gathering process includes the customer 120 accepting an offer for information pertaining to the secondary product, such as, for example, an application for the same. The primary marketer 130 gathers customer information, such as customer name, mailing address, email address, phone number, and the like. The customer information may further comprise type of primary product, primary product price, type of payment (full payments or installments), method of payment (check, money order, or credit card), gender, age, geographical region, geographical locale (rural or urban), time of purchase (day or night, weekday or weekend), source of order (specific advertisement medium to which the customer is responding), economic status, and the like. In one embodiment, the customer provides the customer information by answering questions over the telephone, responding to menu selections in voice mail, completing an email questionnaire, completing a mail-in questionnaire, or the like.

In one embodiment, the primary marketer 130 further categorizes the customer information into classification data. In other embodiments, the secondary marketer 110 and/or market facilitator 160 may categorize the customer information into the same or different classification data. The classification data can comprise customer categories, customer lists and the like. For example, a Category 1 customer may comprise a customer that purchased a very expensive item from the primary marketer 130 and a Category 10 customer may comprise a customer that purchased an inexpensive item, with categories 2-9 falling in between. In another example, the customer information can be used to create customer lists based on gender, age, interests, geographic region, geographical locale, (rural or urban), primary product price, time of purchase (day or night, weekday or weekend), source of order (specific advertisement medium to which the customer is responding), economic status, or the like.

In another embodiment, the secondary marketer 110 may use the customer information, the customer categories, the customer lists or some or all of the same, to create or evaluate marketing strategy, market penetration, market demographics, and the like. In another embodiment, the market facilitator 160 may advantageously use the customer information, the customer categories, the customer lists or some or all of the same to evaluate marketing strategy, market penetration, and market demographics, and the like, for the offering entity 120.

As described in the foregoing, the gathering process of FIG. 3, can advantageously increase customer activations, acceptances, and actual use of the secondary product by furnishing a mechanism for a customer pre-approved follow-up contact. Additionally, the customer data and its further classification permit the primary marketer 130, the secondary marketer 110, or the marketing entity 160 to refine which secondary product is offered, how the secondary product is offered, the appearance of the secondary product application, or the like, to create a more appealing, personalized secondary product in which customer acceptance and activation rates are increased.

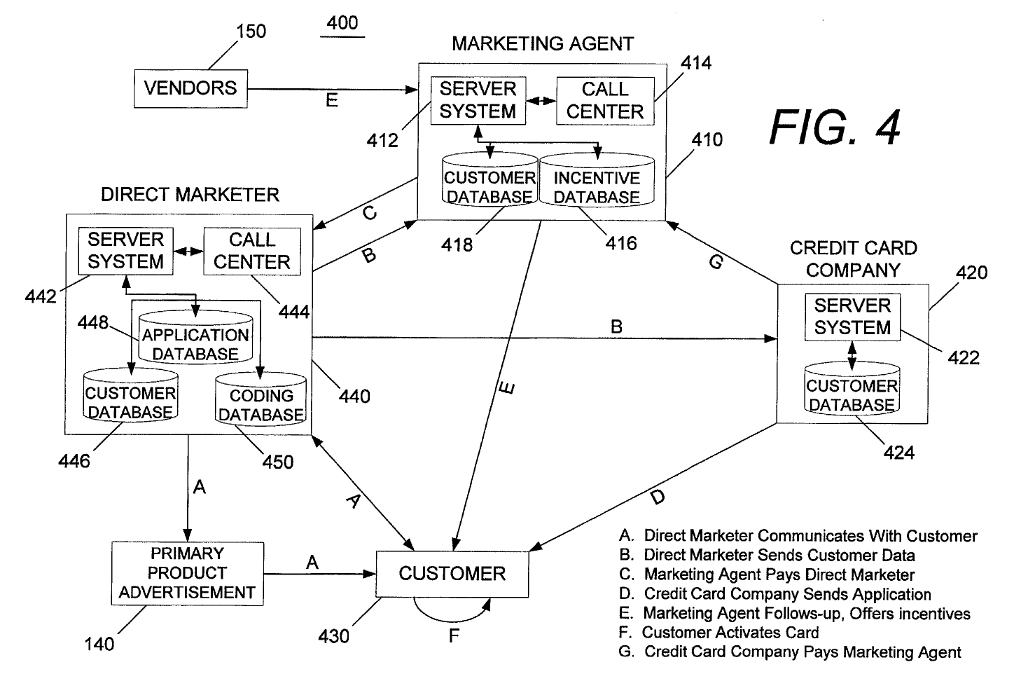

FIG. 4 illustrates an embodiment of targeted receptivity marketing system 400. As shown in FIG. 4, the system 400 includes a marketing agent 410, a credit card company 420, and a direct marketer 440 communicating with one another and at least one customer 430 to encourage the customer 430 to, for example, activate a new credit card of the credit card company 420. Similar to the marketing system 100, the direct marketer 440 generally mass markets one or more primary products through its primary product advertisements 140. The customer 430 generally contacts the direct marketer 440 to inquire regarding the primary product, at which point the direct marketer 440 offers the customer 430 an application for a credit card from the credit card company 430. When the customer 430 accepts the offer, customer information corresponding to the accepting customer is gathered and eventually forwarded to the credit card company 420, which can forward the application to the customer 430. The marketing agent 410 can follow up and optionally offer a variety of incentives to the customer 430 to encourage the customer 430 to return the application or activate the credit card.

As discussed in the foregoing, each of the offer from direct marketer 440, the sending of the application to the customer 430, and the follow up contacts with the same may be customized based on customer information. According to one embodiment, the customization can advantageously be based on customer categories, demographic information, or the like.

As shown if FIG. 4, the direct marketer 440 can comprise a server system 442, a call center 444, a customer database 446, an application database 448, and a coding database 450. The call center 444 communicates with the server system 442, which stores or retrieves data from the customer database 446, the application database 448, and the coding database 450. According to one embodiment, a skilled artisan will recognize from the disclosure therein that the foregoing databases can comprise one or more logical or physical database files or systems, stored in one or more logical, physical, or geographical locations communicating with one or more sever systems.

FIG. 4 also shows the marketing agent 410 comprising a server system 412, a call center 414, an incentive database 416, and a customer database 418. The call center 414 communicates with the server system 412, which stores or retrieves data from the incentive database 416 and the customer database 418. The marketing agent 410 communicates with vendors 150, which may, at least in part, create incentive data stored in the incentive database 416. Similar to the databases disclosed in the foregoing, the databases can comprise one or more logical or physical database files or systems, stored in one or more logical, physical, or geographical locations communicating with one or more sever systems.

FIG. 4 also shows the credit card company 420 comprising a server system 422, which stores and retrieves data from a customer database 424. The server systems 412, 422, 442 communicate with each other so as to be able to distribute and process data between one another, such as, for example, the foregoing customer data, customer categories, customer lists, customized or other application data, scripts for direct marketers, or the like.

As shown in FIG. 4, event A, the direct marketer 440 advertises the primary product or products to the customer 430 through the advertisement 140. Advertisement media include print, magazines, magazine inserts, newspapers, billing inserts, direct mailings, mass mailings, television, radio, voice mail, email, internet, websites, internet banners, catalogs, and the like. The direct marketer 440 may offer more than one primary product through different advertisements 140.

The customer 430 receives the primary product advertisement 140 and responds, for example, by telephoning the direct marketer call center 444. The customer 430 contacts the direct marketer 440 for customer service, for general inquiries or to purchase the primary product, and during this contact, the direct marketer 440 offers the customer 430 a credit card application from the credit card company 420. The credit card company 420 may have more than one application and type of credit card service being offered by the direct marketer 440. The direct marketer 440 may customize how the credit card application is offered or which credit card application is offered based, at least in part, on customer information noted during the sale of the primary product. The information concerning the various credit card applications is retrieved by the direct marketer server system 442 from the application database 448.

Focusing now on the application database 448, the application data stored therein can comprise information on the various credit card applications offered by the credit card company 420 and different offer scripts designed for different customers 430. For example, the script may comprise the offer for the credit card application that the direct marketer 440 reads to the customer 430 after the customer 430 has concluded his reason for contacting the direct marketer 440. The script may be written by the direct marketer 440, the marketing agent 410, the credit card company 420, some or all of the same, or the like. For example, the customer 430 contacting the direct marketer 440 in inquire about a mop may be offered a different credit card service than the customer 430 inquiring about aluminum siding. In another example, the customer 430 in the Midwest might be offered an application for a credit card in a different manner than the customer 430 from New York City. Different versions of the scripts and different credit card applications are organized in the application data into different demographic categories which can be defined by the direct marketer 440, the marketing agent 410, or the credit card company 420.

After the offer, the customer 430 may accept the offer of the credit card application. The call center 444 collects and stores customer information supplied by the customer 430 in customer database 446. The direct marketer 440 may also ask the customer 430 for additional information, such as, for example, the customer's name, mailing address, email address, phone number, amount of primary product purchase, type of payment (check, money order, or credit card), method of payment (check, money order, or credit card), gender, age, geographical region, geographical locale (rural or urban), time of day purchase made, source of order (specific advertisement medium to which the customer is responding), economic status, and the like.

The server system 442 may further categorize the customer data 446 by generating or otherwise applying coding data from the coding database 450. As discussed in the foregoing, the coding data can comprise a customer category, a customer interest, a customer age group, or the like. For example, the customer 430 who purchases a book titled “Bow to Grow Roses” may be classified as having an interest in gardening. In yet another example, the customer 430 who purchases “The Best of the 50's Music” may be grouped in a different category than the customer 430 who purchases “The Best of the 90's Music”.

FIG. 4 shows event B, including the transmission of some or all of the customer data and/or coding data to the server system 442 of the marketing agent 410, the server system 422 of the credit card company 420, or both. The marketing agent 410 receives customer data from the direct marketer 440 and stores the same in customer database 418. The marketing agent 410 may further process the customer data to create, for example, the foregoing customer lists. As discussed in the foregoing, the customer data can include the amount of primary product purchase, type of payment (check, money order, or credit card), gender, age, geographical region, time of day purchase made, and the like, and customer lists based on, for example, customer age, customer gender, customer interests, customer geographic region, or the like. The customer data can be organized into demographic categories, which can be defined by the direct marketer 410, the credit card company 420, or some or all of the same.

In one embodiment, the marketing agent 410 uses the customer information and customer lists of the customer data to generate, revise, evaluate, or the like, the marketing strategy, market penetration, market demographics, and the like, of the credit card company 420. The marketing agent 410 may analyze the customer data and customer lists to gain knowledge of which product offers garner more customer acceptance. The marketing agent may refine the customer offers based on information from previous offers to increase product acceptance. Additionally, the marketing agent 410 may analyze the customer data to determine which, if any, second product extensions may be offered. These aforementioned additional analyses may be iterative processes with further refinement as more data is collected.

The aforementioned additional analyses may be performed by the marketing agent 410, the direct marketer 440, the credit card company 420, all, some, a combination of the same, or the like.

The marketing agent 410 may transmit at least a portion of the customer data through the marketing agent server system 412 to the credit card company server system 422 where it is stored in the credit card company customer database 424.

The credit card company 420 receives customer data and/or coding data. The received data is stored in the customer database 424 and may comprise some or all of the foregoing information associated with customer contact. The server system 422 tracks which customers 430 returned a completed credit card application, which customers 430 were sent a credit card, and which customers 430 activated the credit card.

At event C, the direct marketer 440 receives compensation from the marketing agent 410, the credit card company 420, or both. The compensation may be for each credit card application offered to the customer 430 or for a positive action performed by the customer 430, such as returning the completed application or activating the credit card. The direct marketer 440 may be compensated on a sliding scale to provide incentive to expose more customers 430 to the credit card application offer.

At event D, the credit card company 420 may customize the credit card application based on the customer data. For example, the category 1 customer, who spent more money with the direct marketer 440, may receive an application for a premium credit card, such as a gold card, and a category 10 customer, who spent less money with the direct marketer 440, may receive an application for a credit card with a standard interest rate. In another embodiment, the printed application may be designed to appeal to a specific customer characteristic such as a particular age group, gender, hobby or interest, regional location, and the like.

The credit card company 420 sends the credit card application to the customer 430. The credit card company 420 can deliver the application through any conventional means, including mail, a special delivery service, email, or the like. In one embodiment, the server system 422 monitors which customers 430 have returned the completed application and stores this information in customer data 424.

At event E, the marketing agent 410 accesses the credit card company customer data 424 to determine if the customer 430 has taken a positive action such as returning the completed credit card application to the credit card company 420 within a predetermined time period. If the customer 430 has not returned the completed application, the marketing agent 410 contacts the customer 430, typically through the marketing agent call center 414. The marketing agent call center 414 may be an integral part of the marketing agent 410 or it may be a contracted entity, such as an outbound call service. In one embodiment, the marketing agent 410 contacts every customer 430 to follow-up on the credit card application and activation process.

The marketing agent 410 may offer the customer 430 incentives to perform the positive action of returning the completed application. According to one embodiment, the incentives can be stored in the marketing agent incentive database 416 and can be retrieved by the marketing agent server system 412. For example, the marketing agent 410 may offer a courier service to pick up and deliver the completed application to the credit card company, bonus points in frequent user clubs, such as frequent flyer clubs, a positive financial balance on the credit card, or the like. The marketing agent 410 may also contract with third-party vendors 150 to offer incentives such as a discount on the cost of the vendor's products, a positive balance on the credit card toward the purchase of the vendor's products, coupons valid at the vendor's stores, and the like.

Through the foregoing vendor participation, the vendor 150 advantageously increases the number of customers 430 in the vendor's store. For example, to provide a positive motivation for the customer 430 to return the completed credit card application, the marketing agent 410 may offer the customer 430 a 10% discount on the customer's first credit card purchase at the ABC Store. The incentive would be redeemable upon credit card approval and activation of the credit card at the ABC Store. The ABC store benefits by enticing more customer into the store and may therefore, increase its customer base.

The customer 430 returns the completed credit card application to the credit card company 420. Upon receipt of the completed credit card application, the credit card company 420 processes the application and sends the credit card to the customer 430. The credit card company 420 monitors which customers 430 have activated the credit card and stores this information in customer data 424.

The marketing agent 410 again accesses the credit card company customer database 424 to determine if the customer 430 has taken the positive action of activating the credit card. If the customer 430 has not activated the credit card, the marketing agent 410 follows-up with the customer 430, typically by calling the customer 430 through the marketing agent call center 414. To encourage the customer 430 to activate the credit card, the marketing agent 410 may offer the customer the same or additional incentives stored in the incentive database 416.

When the customer 430 has activates the credit card, at event G, the marketing agent 410 receives compensation from the credit card company 420 for facilitating a new credit card activation. The marketing agent 410 may receive compensation for each new credit card activation, each completed credit card application returned to the credit card company 420, each follow up contact, other intermediate milestones, some or all of the same, or the like.

In the targeted receptivity marketing system 400, the customers 430 of the direct marketer 440 are offered the credit card application from the credit card company 420 when they respond to the advertisement 140 from the direct marketer 440. These customers 430 have already responded to the primary product advertisement 140 and are pre-selected to be more likely to respond to an additional product offer. Through the use of customer data, the offer, the application, and the specific credit card service may be customized to have greater appeal to the customer. Additionally, the marketing agent 410 contacts the customer 430 to increase the likelihood of the customer 430 returning the credit card application and activating the credit card. To further increase the likelihood of creating a new credit card customer, the marketing agent 410 may offer the customer 430 incentives to perform the positive action of returning the credit card application or activating the credit card. By the foregoing mechanisms, the targeted receptivity marketing system 400 for credit card marketing increases the number of credit card application acceptances and credit card activations.

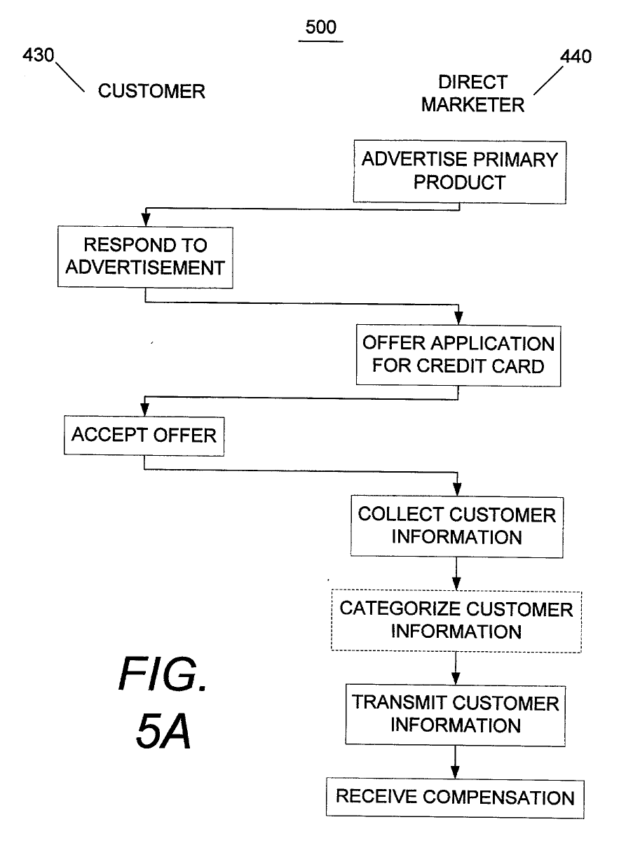

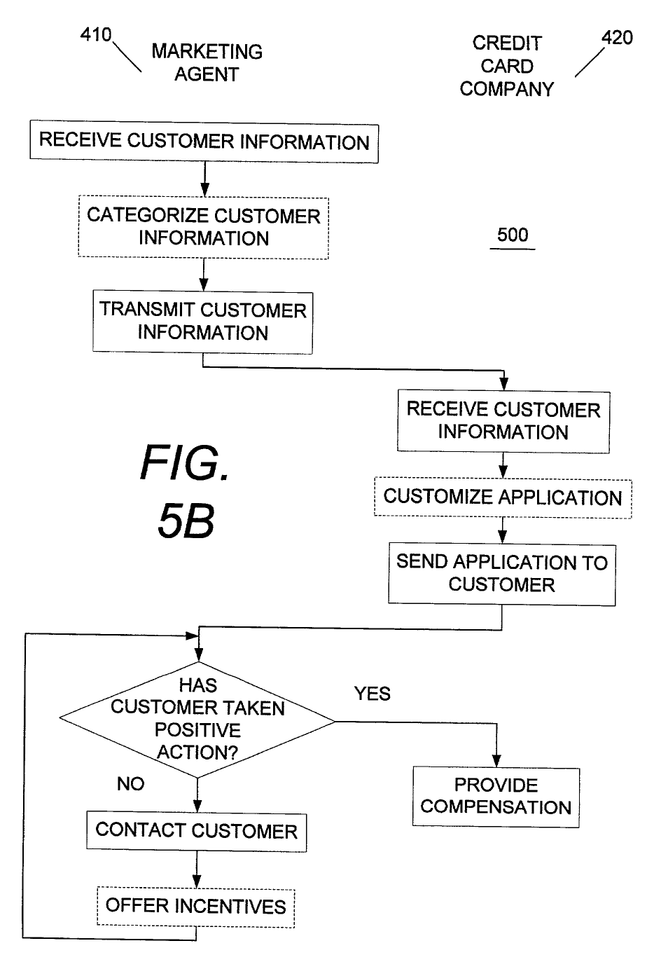

FIGS. 5A and 5B are flowcharts illustrating credit card marketing process 500 according to one embodiment of the present invention. In the credit card marketing process 500, the marketing agent 410 aids the credit card company 420 in acquiring new credit card customers 430 through the marketing actions of the direct marketer 440. FIGS. 5A and 5B illustrate exemplary actions of the customer 430, the direct marketer 440, the marketing agent 410, and the credit card company 420, similar to those describes with respect to FIG. 4.

Although the figures have been described with respect to various preferred embodiments, a skilled artisan will recognize from the disclosure herein a wide number of alternatives. For example, the credit card company 420 can send the credit card instead of the application, the customers 430 can be pre-screened based on data, an offering entity can be a combination, in whole or in part, of the functions of the marketing agent 410 and the credit card company 420, the internet could be utilized to contact customers or receive customer contact instead of call center processing, or the like.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A method acquiring credit card customers from the customers of direct marketed products, the method comprising:
advertising through a direct marketer a direct marketed product;
receiving a customer contact from a customer regarding the direct marketed product;
offering an application for a credit card from at least one financial institution during the customer contact;
recording a customer acceptance of the application;
transferring the customer acceptance to the at least one financial institution;
providing the application to the customer;
when the credit card is not activated, initiating a follow-up customer contact with the customer; and
receiving compensation for activation of the credit card.

2. The method of claim 1, further comprising when the application is not returned, initiating a follow-up customer contact with the customer

3. A method of acquiring customers for secondary products from customers of direct marketers, the method comprising:
using a direct marketer to offer a secondary product to customers contacting the direct marketer regarding a direct marketed product;
using a direct marketer to record customer data when a customer accepts the secondary product;
receiving the customer data;
using the customer data to supply information related to the secondary product to the customer; and
when the customer takes one or more positive actions related to the information, providing the secondary product to the customer.

4. The method of claim 3, further comprising when the customer fails to take the one or more positive actions, initiating a follow-up customer contact with the customer.

5. The method of claim 4, further comprising offering incentives to the customer during the follow-up customer contact to encourage the customer to take at least one of the one or more positive actions.

6. The method of claim 3, further comprising processing the customer data.

7. The method of claim 6, wherein the processing the customer data includes categorizing the customer data by information related to the direct marketed product.

8. The method of claim 7, wherein the information related to the direct marketed product includes the price of the direct marketed product.

9. The method of claim 7, wherein the information related to the direct marketed product includes information related to where the direct marketed product was advertised.

10. The method of claim 6, wherein the processing the customer data includes categorizing the customer data by demographic statistics including one of age, sex, geographic location, and time of day, week or year the customer contacted the direct marketer.

11. The method of claim 3, wherein the secondary product comprises a credit card, and the information related to the secondary product comprises an application for the credit card.

12. The method of claim 11, wherein the one or more positive actions include one of returning the application and activating the credit card.

13. The method of claim 3, further comprising compensating the direct marketer.

14. The method of claim 13, wherein the direct marketer is compensated when the customer data is taken from the customer.

15. The method of claim 13, wherein the direct marketer is compensated when the customer data is transferred from the direct marketer.

16. The method of claim 13, wherein the direct marketer is compensated when the customer takes the one or more positive actions.

17. The method of claim 3, further comprising receiving compensation from a supplier of the secondary product.

18. The method of claim 17, wherein the compensation is received when the information is supplied to the customer.

19. The method of claim 17, wherein the compensation is received when the customer takes the one or more positive actions.

20. The method of claim 4, further comprising receiving compensation from a supplier of the secondary product when a follow-up customer contact is made with the customer.

21. A marketing system which targets customers of direct marketed products for solicitation of secondary products, the marketing system comprising a market facilitator who arranges for a direct marketer to receive inquires from at least one customer interested in one or more directed marketed products, to offer the customer at least one secondary product, and to gather customer data associated with the customer, wherein the market facilitator also arranges for an offering entity to receive the customer data, supply the customer with information related to the secondary product, and wherein when the customer fails to act on the information within a predetermined time, the market facilitator also contacts the customer regarding the secondary product.

22. The marketing system of claim 21, wherein the market facilitator further participates in the customization of the offer to the customer.

23. The marketing system of claim 22, wherein the customization is based on the direct marketed products.

24. The marketing system of claim 22, wherein the customization is based on demographic statistics including one of age, sex, geographic location, and time of day, week or year the customer contacted the direct marketer.

25. The marketing system of claim 21, wherein the market facilitator further participates in the customization of the information supplied to the customer.

26. The marketing system of claim 25, wherein the customization is based on the direct marketed products.

27. The marketing system of claim 25, wherein the customization is based on demographic statistics including one of age, sex, geographic location, and time of day, week or year the customer contacted the direct marketer.
